(19) United States
(12) Patent Application Publication
(10) Pub. No.: US 2013/0323358 A1
(43) Pub. Date: Dec. 5, 2013

(54) SUPPRESSED-POP POPCORN

(71) Applicant: FRONT RANGE SNACKS, INC., Centennial, CO (US)

(72) Inventors: Timothy DeVere Bradley, Englewood, CO (US); Penny Kay Hurlston, Broomfield, CO (US); Jesse Van Hallowell, Frederick, CO (US)

(73) Assignee: FRONT RANGE SNACKS, INC., Centennial, CO (US)

(21) Appl. No.: 13/833,052

(22) Filed: Mar. 15, 2013

Related U.S. Application Data
(60) Provisional application No. 61/653,330, filed on May 30, 2012.

(51) Int. Cl. A23L 1/18; A23L 1/105

(52) U.S. Cl. CPC A23L 1/1812; A23L 1/1055
USPC 426/18; 426/625

(57) ABSTRACT

Suppressed-pop popcorn is made by soaking popcorn kernels in a room temperature aqueous enzyme solution. The enzyme solution degrades the pericarp structure of the popcorn kernels and increases the moisture content within the popcorn kernels. As a result, the popcorn kernels partially pop when exposed to heat, yielding a crunchy, orally satisfying snack.

### CROSS-REFERENCE TO RELATED APPLICATIONS

The present application claims benefit of priority to U.S. Provisional Patent Application No. 61/653,330 entitled “Suppressed-Pop Popcorn” and filed on 30 May 2012, which is specifically incorporated by reference herein for all that it discloses or teaches.

### BACKGROUND

Maize (or corn) constitutes a staple food in many regions of the world because of its availability, flexibility, and generally acceptable taste and texture to humans. Further, corn possesses beneficial nutritional features (e.g., it is a whole-grain and it contains antioxidants in the hull), especially when the corn is not over-processed (e.g., not fried). Still further, portable corn snacks (e.g., popped popping corn or popcorn) are advantageous in that humans may conveniently consume a desired portion of corn in a variety of locations and under a variety of time limitations.

Popcorn (e.g., yellow popcorn, mushroom popcorn, and white popcorn) is corn that expands from a kernel and puffs up when heated under certain conditions. Such corn is able to pop because, like amaranth grain, sorghum, quinoa, and millet, its kernels have a hard, moisture-sealed hull and a dense starchy interior. This allows steam pressure to build inside the kernel when heated until an explosive “pop” occurs.

Often a portion of each batch of popcorn only partially pops, yielding partially popped kernels and/or fails to pop at all, yielding un-popped kernels (i.e., old maids). Un-popped or partially popped kernels may be caused by insufficient internal moisture to create enough steam for a fully explosive pop. Un-popped or partially popped kernels may also be caused by a faulty (e.g., leaky or otherwise weakened) kernel hull. In some instances, partially popped kernels are advantageous over fully popped kernels. For example, the partially popped kernels can exude a denser taste experience and may offer a more orally satisfying “crunch” (i.e., they are harder) than fully popped kernels. Further, un-popped kernels can be too hard, making them unpleasant to chew and consume.

### SUMMARY

Implementations described and claimed herein address the foregoing problems by providing a suppressed-pop popcorn product comprising a statistically significant sample of partially popped kernels having expanded foam starch with an average density ranging from approximately 0.25 to approximately 0.33 grams per cubic centimeter and less than approximately 1% by weight fractured pericarp structures separated from the expanded foam starch.

Implementations described and claimed herein further address the foregoing problems by providing a method of manufacturing a suppressed-pop popcorn product from enzyme treated popcorn kernels comprising soaking a statistically significant sample of popcorn kernels in an aqueous enzyme solution; and heating the soaked kernels to a temperature sufficient to partially pop the kernels to produce the popcorn product, wherein an average density of the popcorn product ranges from approximately 0.25 to approximately 0.33 grams per cubic centimeter and less than approximately 1% by weight of the popcorn product is fractured pericarp structures separated from the expanded foam starch of the individual popped kernels.

Implementations described and claimed herein still further address the foregoing problems by providing a suppressed-pop popcorn product comprising a statistically significant sample of un-popped popcorn kernels, each with an enzyme-degraded pericarp without substantial visible cracks or fissures in the pericarp and an average moisture content within the popcorn kernels of approximately 28% to approximately 38%.

Other implementations are also described and recited herein.

### BRIEF DESCRIPTIONS OF THE DRAWINGS

FIG. 1 illustrates example operations for treating popcorn kernels to become a suppressed-pop kernels and popping suppressed-pop kernels.

FIG. 2 illustrates example popcorn kernels soaking in an enzyme solution.

FIG. 3 illustrates an example suppressed-pop kernel with a weakened pericarp structure.

FIG. 4 illustrates an example suppressed-pop kernel with heat applied thereto and pressure expansion increasing within the kernel.

FIG. 5 illustrates an example suppressed-pop kernel with heat applied thereto and fissures developing in a pericarp as increasing pressure exceeds a pressure holding capacity of the pericarp.

FIG. 6 illustrates an example suppressed-pop kernel with heat applied thereto and suppressed expansion of starch within the kernel after failure of a pericarp.

### DETAILED DESCRIPTIONS

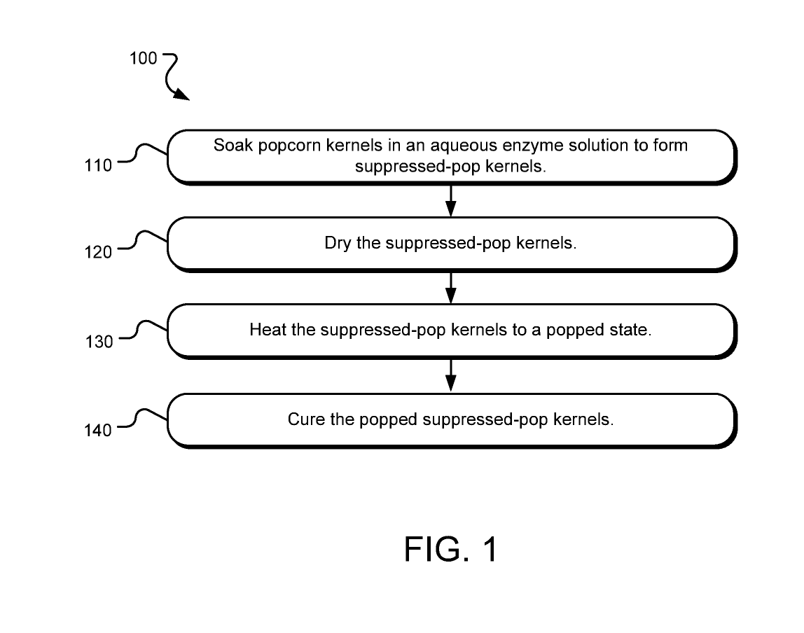

FIG. 1 illustrates example operations 100 for treating popcorn kernels to become suppressed-pop kernels and popping the suppressed-pop kernels. A soaking operation 110 soaks the popcorn kernels in an enzyme solution for a period of time sufficient to weaken (or degrade, chemically break-down, or degenerate) the kernel pericarps (i.e., hulls). The soaking operation 110 also may be used to increase the moisture content within the individual popcorn kernels to a desired level (see below). The resulting popcorn kernels are referred to herein as suppressed-pop kernels.

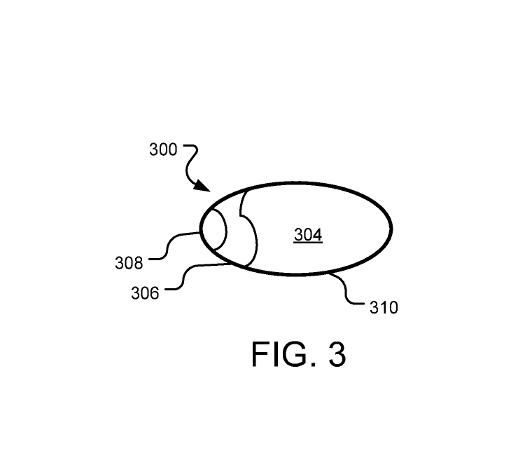

The popcorn kernels may be of any variety of corn that is capable of a suppressed pop using the operations 100 of FIG. 1 (e.g., yellow popcorn, mushroom popcorn, and white popcorn). Each popcorn kernel includes a dense endosperm (or starch) component, a somewhat less dense endosperm (or starch) component, and an embryo component enveloped by a pericarp (see FIG. 3). The pericarp is generally water impermeable or of very low permeability.

The enzyme solution is an aqueous solution containing an enzyme that chemically reacts with the pericarps of the individual popcorn kernels, thereby weakening them over time. More specifically, the rigid structure of the pericarps are primarily made up of the polymers cellulose and hemicellulose. The enzyme solution may include one or both of a cellulase, which breaks down bonds between cellulose monomers, and a hemicellulase, which breaks down bonds between hemicellulose monomers. Both the cellulase and the hemicellulase utilize hydrolysis to cleave the chemical bonds of the cellulose and hemicellulose within the pericarps, respectively. The cellulose and hemicellulose components of the pericarps degrade into smaller polysaccharides or completely into their sugar monomers when exposed to the cellulase and/or hemicellulase enzymes over time.

Example cellulases that may be used in the enzyme solution include cellulase 150,000 CU/GM, Accelerase® BG, Accelerase® 1500, and Accelerase® XC. Example hemicellulases that may be used in the enzyme solution include hemicellulase 300,000 HCU/GM, Rohament® CL, and Accelerase® XY. In an example implementation, the enzyme solution includes 0-5% hemicellulase, 0-5% cellulase, and 90-99.0% water by volume. In another implementation, the enzyme solution includes about 0.5% hemicellulase, about 0.5% cellulase, and about 99.0% water by volume. In another implementation, the enzyme solution includes about 0.05% hemicellulase, about 0.05% cellulase, and about 99.9% water by volume. The ratio of enzyme to water in the enzyme solution may be tuned to a desired duration of the enzyme soak and cost considerations of the enzymes.

In an example implementation, an enzyme is mixed with water at a ratio ranging from 50:1 to 150:1, by weight, to form the enzyme solution. The soaking operation 110 may be performed at an ambient or room temperature (e.g., 65-85° F.) for a time period ranging from 24-65 hours (or about 48 hours). Further, moisture from the enzyme solution may be absorbed into the kernels through the weakened pericarps. In other implementations, the soaking operation 110 may be performed at an elevated temperature (e.g., greater than 80° F.). More specifically, an example cellulase enzyme solution achieves greater than 50% relative activity at 60-194° F., greater than 80% relative activity at 90-150° F., and greater than 90% relative activity at 94-147° F. Similarly, an example hemicellulase enzyme solution achieves greater than 50% relative activity at 60-194° F., greater than 80% relative activity at 84-183° F., and greater than 90% relative activity at 127-178° F.

The pH of the enzyme solution may substantially affect the performance of the soaking operation 110. Further, as the enzyme solution chemically interacts with the kernels, the pH of the enzyme solution may change over time. A buffer acid/base additive (e.g., citric acid, bisulfite, and carbon dioxide) may be used to achieve and maintain a desired pH level. Generally, a pH ranging from 2-8 achieves acceptable performance. More specifically, an example cellulase enzyme solution achieves greater than 50% relative activity at a pH of 2-8, greater than 80% relative activity at a pH of 3.2-5.2, and greater than 90% relative activity at a pH of 3.5-4.6. Similarly, an example hemicellulase enzyme solution achieves greater than 50% relative activity at a pH of 2-8, greater than 80% relative activity at a pH of 4.2-5.8, and greater than 90% relative activity at a pH of 4.4-5.5.

The enzyme solution may be agitated during the soaking operation 110 to facilitate and/or expedite weakening of the pericarps. In some implementations, the enzyme solution causes cracks to form in the pericarps when soaked for a period of time. In other implementations, the enzyme solution merely softens the pericarps, reducing their structural integrity and pressure holding capability without inducing substantial visible cracks or fissures (e.g., visible cracks or fissures in less than 1% of a statistically relevant sample of kernels) in the pericarps.

When the soaking operation 110 has sufficiently weakened the pericarps, a drying operation 120 dries the exterior of the suppressed-pop kernels. More specifically, the popcorn kernels are removed from the enzyme solution and the exterior surfaces of the suppressed-pop kernels are dried. This may be accomplished by drip-drying, wicking-action, forcing drying air over the kernels, and/or applying a low-level of heat to the suppressed-pop kernels.

A heating operation 130 heats the suppressed-pop kernels to a temperature sufficient to create a pressure within the kernels that exceeds the pressure holding capacity of the kernels. More specifically, after operations 110, 120 are completed, the suppressed-pop kernels contain a certain amount of moisture (e.g., 28%-38% or 32%-36% moisture content). Further, even after being weakened by the soaking operation 110, the outer hull of the kernel is still capable of holding some pressure (albeit less than an untreated kernel), and the starch inside is almost entirely of a hard, dense type.

As the water within the kernels is heated, the kernel acts as a superheated pressurized steam vessel. Under these conditions, the starch inside the kernel gelatinizes, softens, and becomes pliable. The pressure continues to increase until a breaking point of the pericarps is reached (e.g., at a pressure of about 135 psi and a temperature of about 356° F.). In other implementations, the breaking point of the pericarps is achieved at a pressure less than about 135 psi and a temperature less than about 356° F. The pericarps rupture rapidly, causing a sudden drop in pressure inside the kernels and a corresponding rapid expansion of the steam, which expands the kernel starch and proteins of the endosperm into a dense foam. As the foam rapidly cools, the starch and protein polymers set into a crunchy corn puff The popped suppressed-pop kernels are referred to herein in bulk as suppressed-pop popcorn or suppressed-pop popcorn product.

In an example implementation, the kernels are heated at a temperature of 400-500° F. for a period of about 2-3 minutes in a screw-type commercial popcorn popping machine. Further, achieving the correct temperature, duration, and agitation for the heating operation 130 is important to provide consistent heating to the un-popped kernels and prevent burning of the popped kernels (e.g., pop 60-98% of the kernels prior to substantially burning any of the popped kernels). Burning is avoided due to the sharp, earthy taste imparted by burnt portions of the kernels, a taste that is considered bad or offensive to many humans. The remaining 2-40% of un-popped kernels are cooked with a majority of the moisture driven out without being burnt and are readily consumable by humans.

Popping results (including average expansion ratio and success rate) are sensitive to the rate at which the kernels are heated, for example. If heated too quickly, the steam in the outer layers of the kernels can reach high pressures and rupture the pericarps before the starch in the center of the kernels can fully gelatinize, leading to popped kernels with particularly hard centers. Further, heating too slowly may cause a substantial number of entirely un-popped kernels (e.g., greater than 2%). For example, the tip of each of the kernels that was previously attached to a cob, is not entirely moisture-proof. Further, potential cracks in the pericarp created by the soaking operation 110 render the kernels not entirely water vapor-tight. When heated slowly, steam can leak out of the tip and/or cracks fast enough to keep the pressure from rising sufficiently to fracture the pericarps and pop the kernels.

A curing operation 140 continues to heat the popped suppressed-pop kernels to dry out the popped kernels. After the kernels are popped, additional heat may be applied to the kernels to quickly dry out remaining moisture and prevent the popped kernels from becoming chewy. The curing operation 140 may be performed contiguously with the heating operation 130 or at a different time and at a different temperature than the heating operation 130 (e.g., about 15-45 seconds at about 380-450° F.). In some implementations, the curing operation 140 is not performed, as residual heat from the heating operation 130 is sufficient to prevent chewiness and/or toughness in the popped kernels. In one implementation, the suppressed-pop popcorn has a moisture content of 2-3% by weight.

The suppressed-pop popcorn may be characterized as a statistically significant sample (e.g., a sample with a significance level of 5%) of multiple popped suppressed-pop kernels. In one implementation, the statistically significant sample of multiple popped suppressed-pop kernels ranges from about 0.275-0.295 grams per cubic centimeter. Further, the statistically significant sample of multiple popped suppressed-pop kernels yields about 72 popped kernels per 10 grams of product. Still further, the statistically significant sample of multiple popped suppressed-pop kernels has less than 1% (or less than 0.5%) of separated hulls per 100 grams of product. In other implementations, the statistically significant sample of multiple popped suppressed-pop kernels has less than 5% of separated hulls per 100 grams of product.

Further, the statistically significant sample of multiple popped suppressed-pop kernels (e.g., popped kernel 600) yields an average compressive strength of about 10-30 Newtons. As a result, the suppressed-pop popcorn product provides an orally crunchy sensation without being too hard for an average human to chew. Further, a volumetric expansion ratio from un-popped kernels to partially popped kernels is about 1:3.5.

The enzyme solution used during the soaking operation 110 uniformly weakens the pericarps such that when the treated kernels are heated in the heating operation 130, the pericarps fracture uniformly and remain substantially attached to the popped kernels. In contrast, applying heat during the soaking operation 110 sufficient to substantially fracture the pericarps may yield an inconsistent popped product from which the pericarp may tend to separate during or after the heating operation 130.

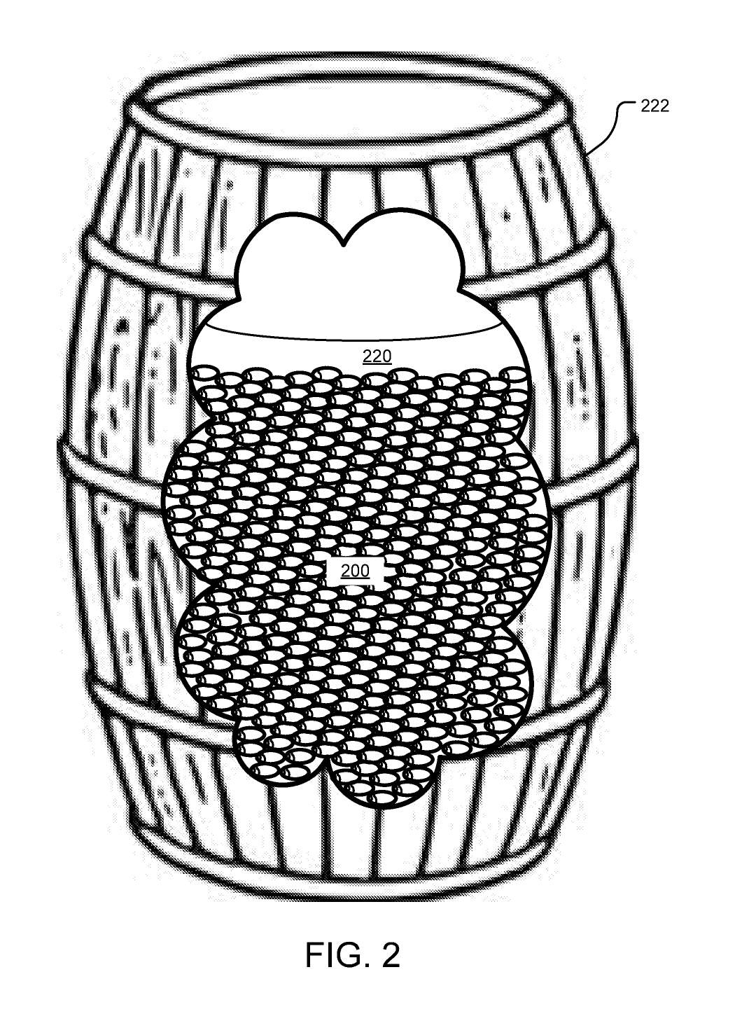

FIG. 2 illustrates example popcorn kernels 200 soaking in an enzyme solution 220. The kernels 200 are placed in a container 222 (e.g., a barrel) with sufficient enzyme solution 220 to cover the popcorn kernels 200. The container 222 may be any volume enclosing structure that is substantially inert to the enzyme solution 220 and kernels 200 contained therein (e.g., a plastic or stainless steel container or liner). A side of the container 222 is depicted as transparent to illustrate the kernels 200 and enzyme solution 220 within the container 222. In various implementations, the interior of the container 222 is agitated, pressurized, and/or heated to facilitate the enzyme treatment of the kernels 200.

After soaking in the container 222 for a predetermined period of time, the enzyme solution 220 is drained from the container 222 or the kernels 200 are removed from the container 222. In some implementations, the kernels 200 are rinsed with water. In other implementations, the kernels 200 are rinsed with flavored water to impart flavoring to the kernels 200. The kernels 200 are then dried (e.g., via drip-drying, wicking-action, forcing drying air over the kernels 200, and/or applying a low-level of heat to the kernels 200). The resulting enzyme-treated kernels 200 are referred to herein as suppressed-pop kernels 200.

FIG. 3 illustrates an example suppressed-pop kernel 300 with a weakened pericarp 310. The kernel 300 includes a dense endosperm (starch) component 304, a somewhat less dense endosperm (starch) component 306, and an embryo component 308 enveloped by a pericarp 310. The pericarp 310 is generally water impermeable or of very low permeability. An exception is the interface between the kernel 300 and a cob (not shown) generally at the embryo component 308, where the pericarp 310 may be more permeable. A further exception is permeability at any cracks or fissures formed in the pericarp 310 (e.g., via the enzyme solution 220 of FIG. 2 chemically reacting with and weakening the pericarp 310) or any preexisting cracks or fissures in the pericarp 310.

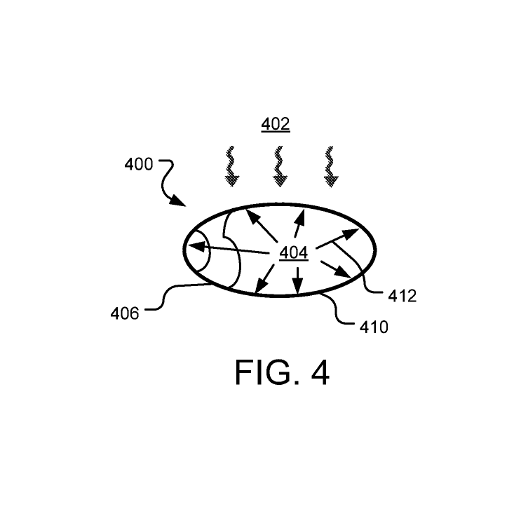

FIG. 4 illustrates an example suppressed-pop kernel 400 with heat applied thereto and pressure expansion increasing within the kernel 400. The heat (illustrated by wavy arrows 402) is added to the kernel 400 to create pressure within the kernel 400 for popping. The heat may be added to the suppressed-pop kernel 400 using any heat source (e.g., a hot-air popper). As the heat is applied to the kernel 400, the temperature of the kernel 400 and corresponding pressure within the kernel 400 increases over time. Water and/or oil within the kernel 400 expands with temperature causing outward pressure on pericarp 410, illustrated by outward oriented arrows (e.g., arrow 412). Further, the starch 404, 406 transforms into a gelatinous and/or softened state.

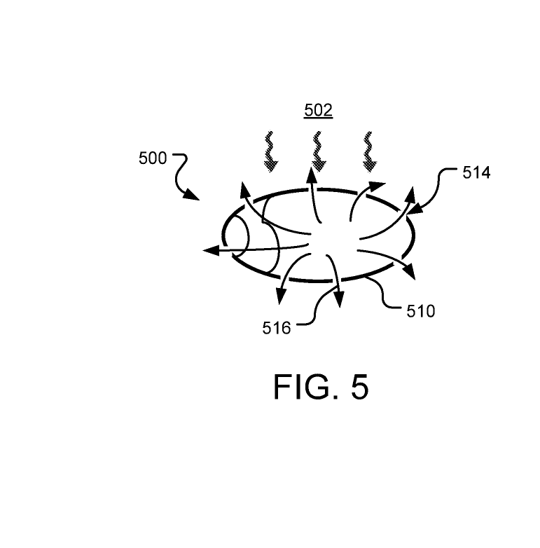

FIG. 5 illustrates an example suppressed-pop kernel 500 with heat applied thereto and fissures (e.g., fissure 514) developing in a pericarp 510 as increasing pressure exceeds a pressure holding capacity of the pericarp 510. Prior to applying the heat (illustrated by wavy arrows 502), the kernel 500 was enzyme-solution treated to weaken the pericarp 510 (e.g., see FIG. 2). As a result, the increasing pressure within the kernel 500 exceeds the pressure holding capacity of the intact pericarp 510 at a lower pressure than with an untreated popcorn kernel. The pressure within the kernel 500 causes the fissures to develop and relieve the pressure within the kernel 500 (as illustrated by arrows, e.g., arrow 516). In other implementations, the pressure within the kernel 500 does not generally cause multiple fissures to develop but instead rapidly ruptures the kernel 500 along a primary rupture line and the kernel 500 explodes with a rapid release of pressure.

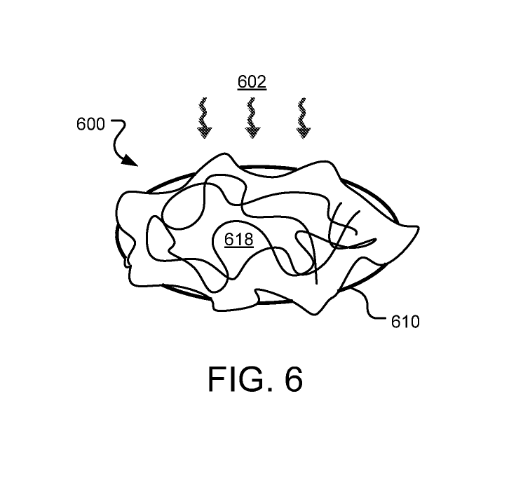

FIG. 6 illustrates an example suppressed-pop kernel 600 with heat applied thereto and suppressed expansion of starch within the kernel 600 after failure of a pericarp 610. When the pericarp 610 fails, the pressurized and gelatinized starch within the kernel 600 quickly boils and expands, forming an expanded foam starch 618. Since the moisture content is higher, and pressure required to cause a failure of the pericarp 610 of the suppressed-pop kernel 600 is lower than for a typical popcorn kernel, expansion of the resulting popped kernel 600 is limited, creating the denser suppressed-pop popcorn kernel 600, as disclosed herein.

Further, the fractured pericarp 610 substantially remains attached to the expanded foam starch 618 as opposed from separating from the popped kernel 600. For example, in a statistically significant sample of suppressed-pop popcorn, less than 1% by weight (e.g., approximately 0.5% by weight) of the fractured pericarp 610 is separated from the product. In practice, the fissures form and foam expansion occurs very rapidly once the pressure holding capacity of the pericarp 610 is exceeded (e.g., this occurs in a fraction of a second).

More specifically, a combination of developing fissures in the pericarp 510 depicted in FIG. 5 and the failure of the pericarp 610 and expansion of the pressurized and gelatinized starch within the kernel 600 of FIG. 6 occurs in a relatively short time period (e.g., less than 0.1 second). This is distinctly shorter than the heating and pressure expansion depicted in FIG. 4, which may occur over a period lasting minutes.

The logical operations making up the embodiments of the invention described herein are referred to variously as operations, steps, objects, or modules. Furthermore, it should be understood that logical operations may be performed in any order, adding or omitting operations, unless explicitly claimed otherwise or a specific order is inherently necessitated by the claim language.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A suppressed-pop popcorn product comprising:
a statistically significant sample of partially popped kernels having expanded foam starch with an average density ranging from approximately 0.25 to approximately 0.33 grams per cubic centimeter and less than approximately 1% by weight fractured pericarp structures separated from the expanded foam starch.

2. The suppressed-pop popcorn product of claim 1, wherein the partially popped kernels have an average moisture content of less than approximately 3%.

3. The suppressed-pop popcorn product of claim 1, wherein the partially popped kernels have an average compressive strength of approximately 10-30 Newtons before substantially compacting.

4. The suppressed-pop popcorn product of claim 1, wherein the pericarp structures are substantially degraded by exposure to an enzyme.

5. The suppressed-pop popcorn product of claim 5, wherein the enzyme-degradation is the result of hydrolysis with one or both of cellulase and hemicellulase.

6. A method of manufacturing a suppressed-pop popcorn product from enzyme treated popcorn kernels comprising:
soaking a statistically significant sample of popcorn kernels in an aqueous enzyme solution; and
heating the soaked kernels to a temperature sufficient to partially pop the kernels to produce the popcorn product, wherein an average density of the popcorn product ranges from approximately 0.25 to approximately 0.33 grams per cubic centimeter and less than approximately 1% by weight of the popcorn product is fractured pericarp structures separated from the expanded foam starch of the individual popped kernels.

7. The method of claim 6, wherein the enzyme solution includes one or both of cellulase and hemicellulase and water.

8. The method of claim 7, wherein the cellulase and hemicellulase comprise less than approximately 2% by volume of the aqueous enzyme solution.

9. The method of claim 6, wherein the soaking operation is performed at approximately 65 to approximately 85 degrees Fahrenheit for approximately 24 to approximately 65 hours.

10. The method of claim 6, wherein the soaking operation is performed at a pH of approximately 3-6.

11. The method of claim 6, further comprising:
drying an exterior surface of the soaked kernels prior to the heating operation.

12. The method of claim 6, wherein the soaking operation does not cause substantial visible cracks or fissures in the pericarp of the enzyme treated popcorn kernels.

13. The method of claim 6, wherein the soaking operation reduces the structural integrity of the pericarp of the enzyme treated popcorn kernels.

14. The method of claim 6, wherein the heating operation causes cracks or fissures in the pericarp as the kernels are partially popped.

15. The method of claim 6, wherein the heating operation is performed using a hot-air popper.

16. The method of claim 6, wherein the heating operation partially pops greater than approximately 98% of the soaked kernels.

17. The method of claim 6, wherein the partially popped kernels have an average expansion ratio of approximately 3.5:1 as compared to un-popped kernels.

18. A suppressed-pop popcorn product comprising:
a statistically significant sample of un-popped popcorn kernels, each with an enzyme-degraded pericarp without substantial visible cracks or fissures in the pericarp and an average moisture content within the popcorn kernels of approximately 28% to approximately 38%.

19. The suppressed-pop popcorn product of claim 18, wherein the enzyme-degradation is the result of hydrolysis with one or both of cellulase and hemicellulase.

20. The suppressed-pop popcorn product of claim 18 configured to partially pop when heated.
